(19) United States
(12) Patent Application Publication
(10) Pub. No.: US 2003/0106714 A1
(43) Pub. Date: Jun. 12, 2003

(54) Use of coiled tubing unit systems in sub sea operations

(76) Inventors: Michael Lee Smith, Banquete, TX (US); David Strickland, Houston, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/021,675

(22) Filed: Dec. 12, 2001

(51) Int. Cl. E21B 7/124; F16L 1/00; B63G 8/42; B63G 9/00; B63B 21/66

(52) U.S. Cl. 175/6; 114/244; 405/158

(57) ABSTRACT

The present invention utilizes a coiled tubing unit at the ocean floor to perform operations previously not possible, or performed in a less efficient manner from the surface of the ocean. The operations of the present invention involve, sub sea drilling, salvage operations, and sub sea pipeline cleanout.

### BACKGROUND OF THE INVENTION

1. Field of the Invention

This invention relates to the use of a coiled tubing unit system in sub sea operations. In the present invention, the coil-tubing unit is placed on or near the ocean floor and therefore may be used either in operations not traditionally performed by coil tubing units or to increase the performance and decrease the cost of other operations that utilized coiled tubing from a surface installation.

2. Description of the Related Art

Coiled tubing units have traditionally been used for various well testing completion and work over operations in oil and gas fields. Coiled tubing itself is traditionally run within other tubulars including tubing and/or casing. When coiled tubing units have been used for offshore operations, the coiled tubing unit has traditionally been placed on the offshore platform and the coiled tubing run through tubulars down into the sub sea well.

Coiled tubing has traditionally been used as a less costly and more versatile alternative to either pulling the tubing string and utilizing the tubing string as a transport mechanism for tools or fluids down hole, or a wire line which is limited in that it can not transport more than a very small amount of fluid down hole and is incapable of being pushed down the hole.

Another application of coiled tubing is to cleanout offshore pipelines, when they become plugged with hydrates, paraffin, produced solids, or other material. Today, these pipeline cleanout operations are generally performed with the coiled tubing unit on an offshore platform. The operation is limited in distance because of the limitations of how far the coiled tubing can be pushed in the pipeline. The tight radii between the riser from the platform, and the seabed pipeline are contributors to limiting the distance the coiled tubing can be pushed into the sub sea pipeline.

One sub sea situation, which heretofore has been difficult to resolve, is the attempted recovery of sunken ships or other large equipment where the ship or equipment has settled into the seabed. Traditionally, lifting plates would be placed under the ship at both bow and stem with lifting cables attached at each end of the lifting plate to facilitate lifting the ship or other object up to the surface of the ocean. When the ship has settled into the seabed a technique is needed to allow placement of the lifting plates under the seabed itself to get under the vessel to facilitate lifting the vessel.

In a similar situation when an existing pipeline or cable resides on or under the ocean floor and it is necessary to facilitate the placement of pipelines, cables or other objects underneath the pipeline, a technique is needed to provide a passageway underneath the pipeline or cable for easy placement.

### BRIEF SUMMARY OF THE INVENTION

The present invention utilizes coiled tubing units on the sea floor to perform operations that were heretofore not performed, or were performed from the surface in a much more limited and expensive way. The present invention embodies a technique to utilize sub sea coiled tubing units to drill under objects on the sea floor. This can be used to place lifting plates or other materials under a ship or other object to facilitate lifting it from the ocean floor. The coiled tubing could be used to go under an object to provide a passageway for other use, or the coiled tubing could be cut and left under the object to create a needed conduit.

The coiled tubing unit can be used in conjunction with a hot tap device to enter a pipeline for a clean out operation from the ocean floor, permitting any easy angle for entry, and extending the reach of the cleanout operation. This is applicable to improve current coiled tubing cleanout operations from platforms, as well as to enable cleanout operations when there is no nearby platform from which to perform the operation.

### BRIEF DESCRIPTION OF THE SEVERAL VIEWS OF THE DRAWINGS

FIG. 1 shows the sub sea arrangement of the preferred technique for salvage operations.

FIG. 2 shows the preferred coiled tubing unit system for sub sea directional drilling in unconsolidated material.

FIG. 3 shows the preferred bending wheel assembly.

FIG. 4 shows the preferred jet nozzle for sub sea drilling in unconsolidated material.

FIG. 5 shows the preferred salvage operation with drilling complete.

FIG. 6 shows the preferred technique of attaching cable to the jet nozzle.

FIG. 7 shows a top view of the preferred modified lifting plate.

FIG. 8 shows a bottom view of the preferred modified lifting plate.

FIG. 9 shows the preferred technique for inserting the modified lifting plate under a submerged ship.

FIG. 10 shows the preferred arrangement for sub sea coiled tubing pipeline cleanout.

FIG. 11 shows the preferred sub sea hot tap structure for the preferred embodiment.

FIG. 12 shows the preferred embodiment of the sub sea coiled tubing system used for pipeline cleanout.

### DETAILED DESCRIPTION OF THE INVENTION

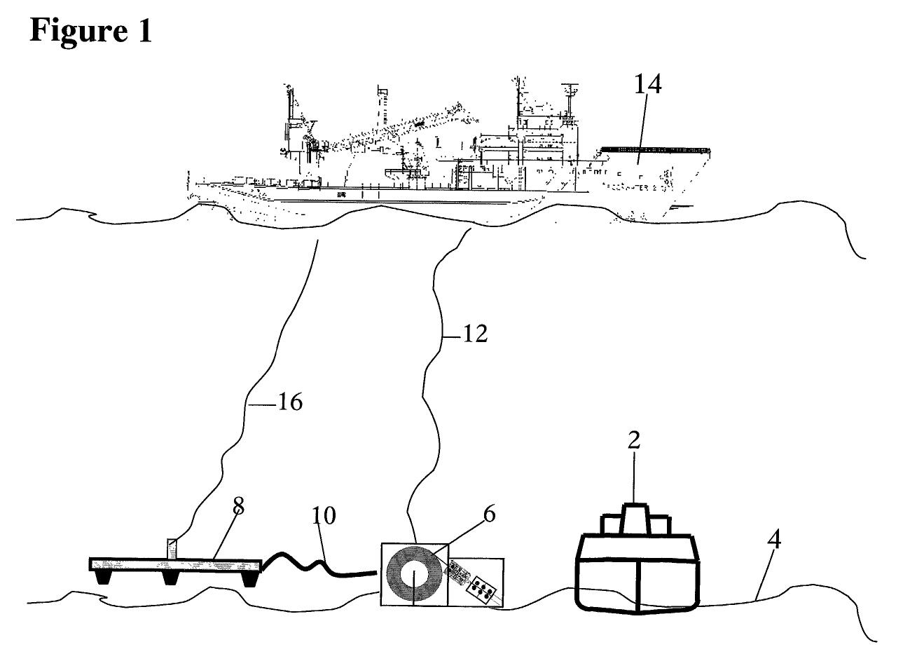

One of the preferred embodiments of the present invention is to utilize a coiled tubing unit on the ocean floor to drill under an object sitting on the ocean floor. In FIG. 1, a Ship 2 is shown on the Ocean Floor 4. The Ocean Floor 4 may be consolidated or unconsolidated. The preferred embodiment described herein is designed for an unconsolidated sea floor. A Coiled Tubing Unit 6 is located adjacent to Ship 2. The Coiled Tubing Unit (“CTU”) 6 is attached to a Fluid Pump 8 through Fluid Connector 10. The CTU 6 is shown with an Umbilical Cable 12 that extends to a Surface Ship 14. The Fluid Pump 8 also has an Umbilical Cable 16 extending up to the Surface Ship 14. The Fluid Pump 8 is sized according to the required hydraulic nozzle rate and pressure requirements. In the preferred embodiment related to salvage operations, the Fluid Pump 8 may use the seawater, and as such only needs to have an intake near the unit. The Fluid Pump 8 is preferably positioned up stream of the current flow towards the Ship 2. The intake is then raised off the Sea Floor 4, preferably either by using a pipe, or by attaching a flotation device to the end of the inlet hose, so that solid material is not unnecessarily pumped through the Fluid Pump 8 and into the CTU 6.

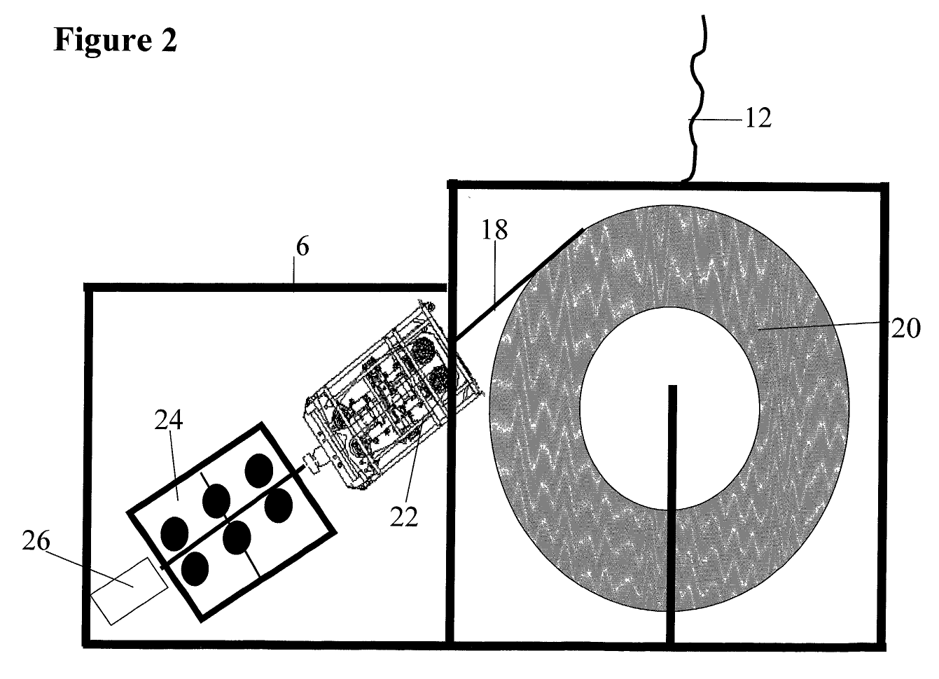

FIG. 2 shows the preferred embodiment of the CTU 6. The Coiled Tubing 18 is contained on Reel 20. In the preferred embodiment, the Coiled Tubing 18 is 2⅜″ OD, but may be any diameter of coiled tubing. The Injector Head 22 feeds the Coiled Tubing 18 forward. The Bending Wheel Assembly 24 is used to create a bend in the Coiled Tubing 18 at the radius desired to go under the Ship 2. In another embodiment, the Bending Wheel Assembly 24 could be replaced by using directional drilling techniques, preferably when drilling through consolidated materials. In further embodiments other pipe bending techniques could be used such as forcing the coiled tubing through a pre-shaped conduit. The Hydraulic Drilling Nozzle 26 is connected to the end of the Coiled Tubing 18. The angle of the Injector Head 22 is fully adjustable so that it could be anywhere from perpendicular to the Sea Floor 4, e.g., the Nozzle 26 is directed downward, to completely horizontal to the ocean floor. The angle of the Injector Head 22 and the bend created by the Bending Wheel Assembly 24 will be designed in light of the distance the CTU 6 will be placed away from the Ship 2 and the required depth of penetration below the seafloor. In the preferred embodiment related to salvage operations, it is preferable to place the CTU 6 as close to the Ship 2 as possible.

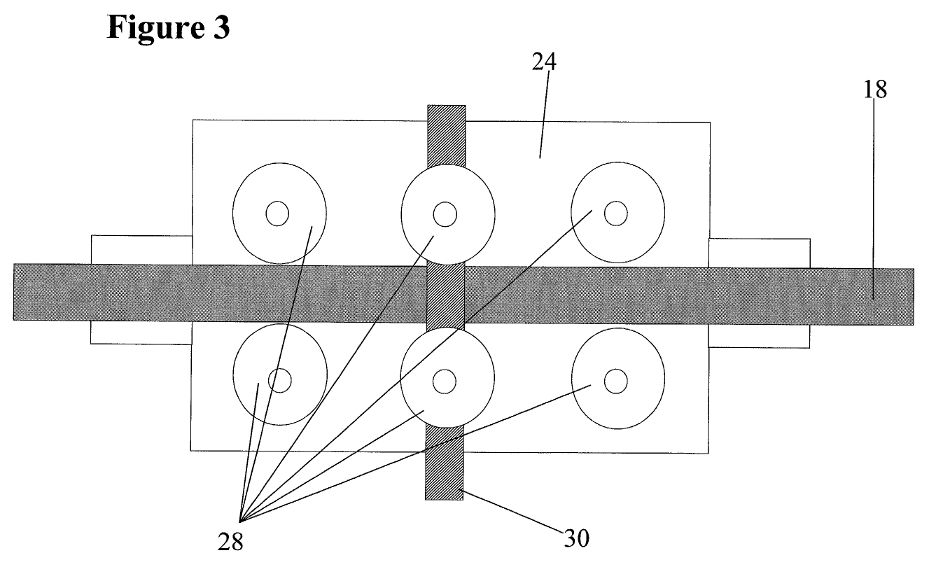

FIG. 3 shows the Bending Wheel Assembly 24 of the preferred embodiment. The Coiled Tubing 18 is shown passing in between the Bending Wheels 28. Bending Wheels 28 use the Angle Adjustment Bar 30, to determine the amount of bend that will be created on Coiled Tubing 18. FIG. 3 shows the Bending Wheel Assembly 24 in a neutral position where no bend would be applied to the Coiled Tubing 18.

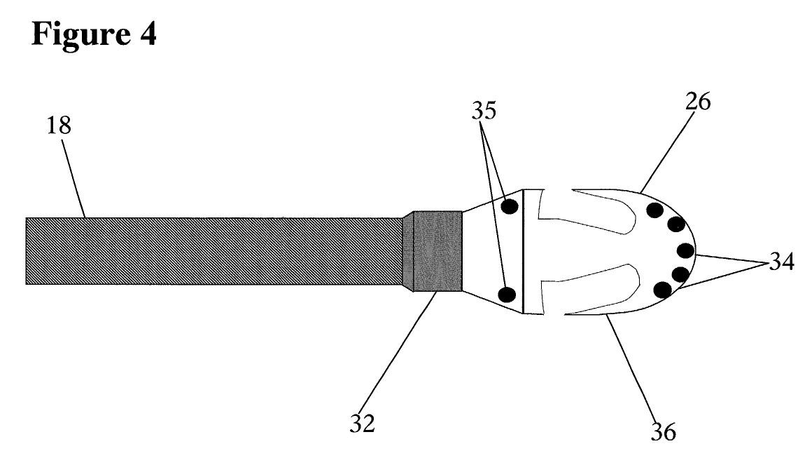

FIG. 4 shows the preferred Hydraulic Drilling Nozzle 26 of the present invention. The Nozzle 26 is connected to the Coiled Tubing 18 with a Coiled Tubing Connector 32. Of course the Nozzle 26 could be integrated on to the end of the Coiled Tubing 18 as well. The Nozzle 26 is a standard jet drilling nozzle that is modified in a number of ways. The size and pattern of the Forward Holes 34 and Backward Holes 35 are designed to account for the specifications of Fluid Pump 8 including the volume of fluid that will be used, and the desired pressure of expelled fluid, so as to create the desired size of borehole. With 2⅜″ OD Coiled Tubing 18, it is preferable to design for a borehole in the unconsolidated Sea Floor 4 sufficient to facilitate the necessary operations. Because how unconsolidated the seafloor is will impact the size of the borehole, on land testing can be performed where, for instance an 8″ borehole through the topsoil can be created. In another embodiment where the Sea Floor 4 is consolidated, a standard rotary drilling bit and motor may be used. For a consolidated sea floor where rotary drilling bits are used, the Bending Wheel Assembly 24 may be replaced with the use of directional drilling techniques. The Nozzle 26 also has backward Holes 35 that face backward toward the Coiled Tubing 18 to accomplish two things, 1) the recently drilled solids are forced backward through the borehole so they do not collect around the Coiled Tubing 18, and 2) the fluid jetting backward helps provide force to pull the Coiled Tubing 18 forward, so the system does not rely exclusively on the Injector Head 22 to force the Coiled Tubing 18 forward. Finally, because in the preferred process of underwater salvage, other cables will need to be pulled back through the borehole, the Nozzle 26 was modified to include slots 36 to permit connection of a return cable.

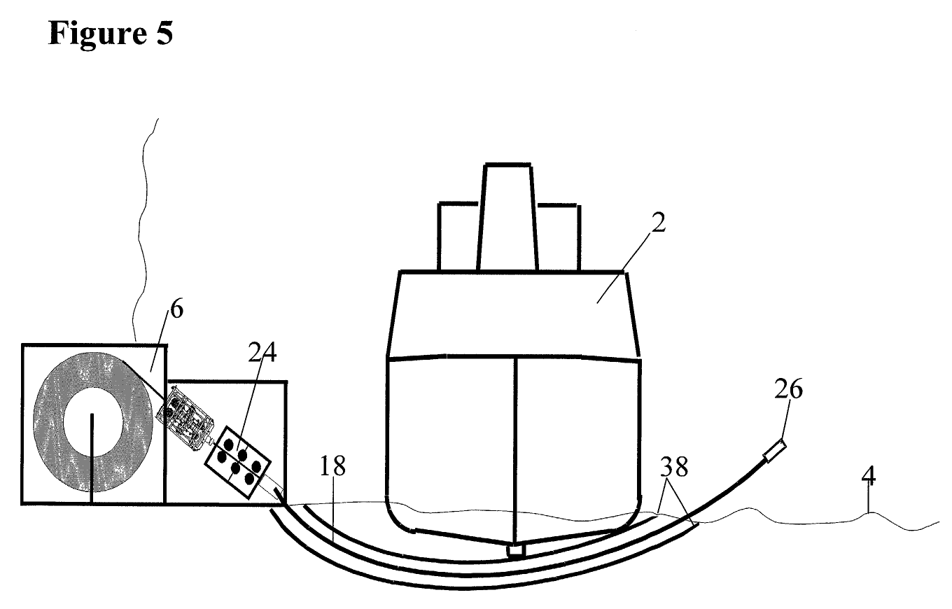

FIG. 5 demonstrates the preferred method at the point and time when the Hydraulic Drilling Nozzle 26 has completely passed under the Ship 2 and has reached the Sea Floor 4 on the far side of the Ship 2. In the preferred embodiment, the CTU 6 is placed in close proximity to the Ship 2, preferably less than 10 feet. The angle of bend applied by the Bending Wheel Assembly 24 is designed to cause the Nozzle 26 and Coiled Tubing 18 to pass close to the bottom of the Ship 2. In the preferred embodiment, the Borehole 38 will be created approximately ten feet from the bottom of the Ship 2 or less. If there is physical damage to the bottom of the ship, the use of the preferred Nozzle 26 will help the Coiled Tubing work its way around or under any obstruction.

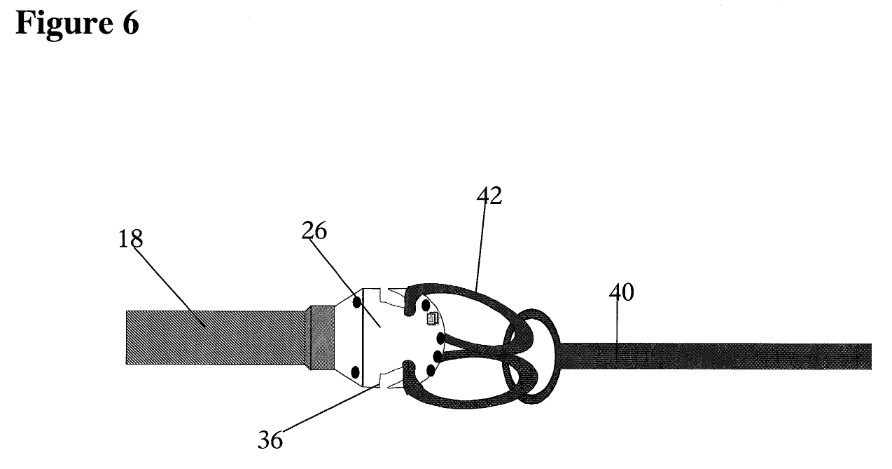

Once the Nozzle 26 is above the Sea Floor 4, a cable may be attached to it to be pulled back through the Borehole 38. A Remote Operated Vehicle (“ROV”) may be used to determine when the Nozzle 26 is above the Sea Floor 4. FIG. 6 shows the preferred embodiment of how a Cable 40 can be attached to the Nozzle 26 using Cable Loops 42 connected in the Slots 36. The Cable 40 is preferably 1½″, and the Cable Loops 42 are preferably 1″. Attaching the Cable Loops 42 to the Nozzle 26 can be accomplished using a ROV. In a salvage operation using lift plates, a stronger cable may be needed. The Cable 40 may be connected to a Sling Cable, which is preferably a 3″ cable designed for very high stress pulling. The CTU 6 is utilized to pull the Cable 40 and the Sling Cable, back through the Borehole 38.

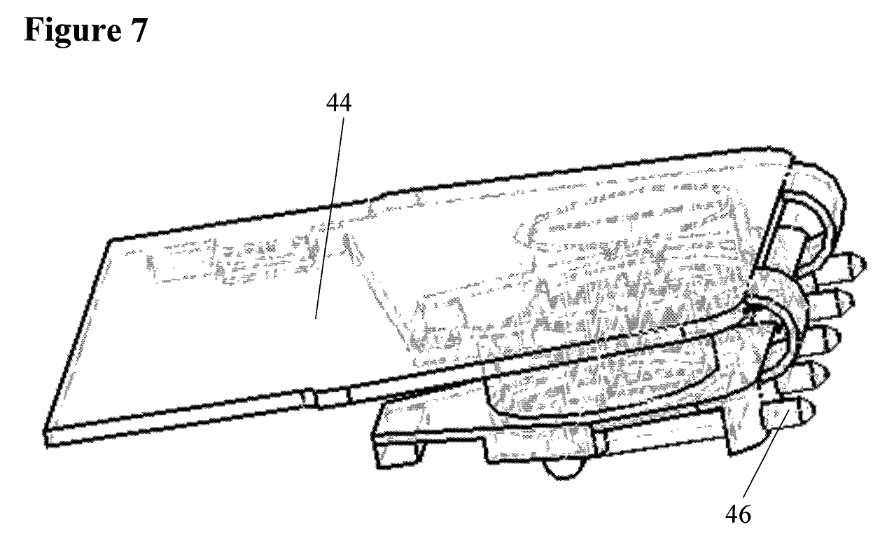

FIG. 7 depicts a Lifting Plate 44 as is commonly used in the salvage industry, that has been modified for use with the present invention to force the lifting plate under the bottom of the Ship 2. The Lifting Plate 44 has been modified to include Jet Nozzles 46 on the front edge of the Lifting Plate 44. While five Jet Nozzles 46 are shown, it may be preferable to use more or less, depending on the required spray pattern. These Jet Nozzles modified versions of the spinning jet nozzle offered by Stone Age, Inc. The number of nozzles and size of nozzles are determined by the spray pattern required. The spray pattern is designed to create a pattern that overlaps with the adjacent pattern, so as to create an opening for the Lifting Plate 44 to pass through.

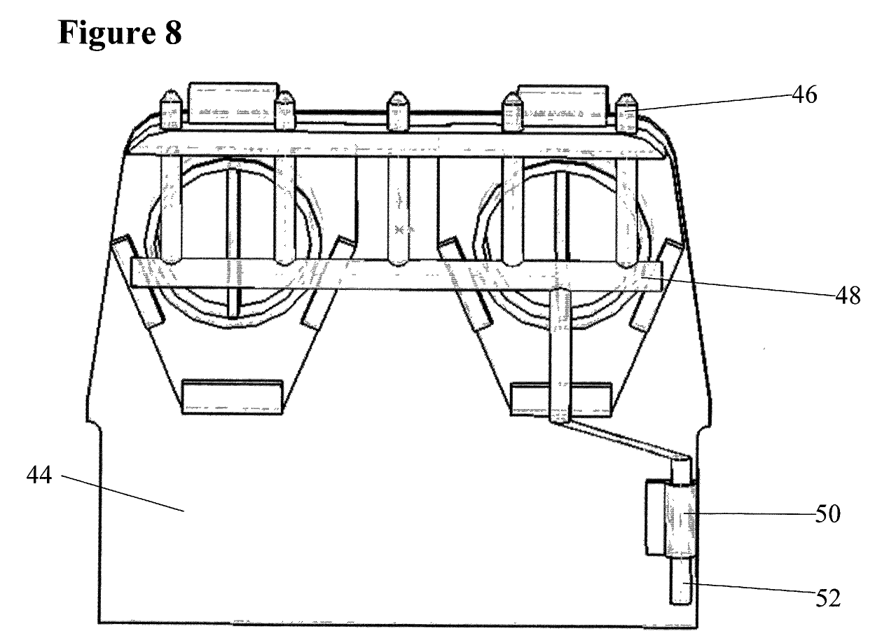

FIG. 8 shows the underside of the modified Lifting Plate 44 of the preferred embodiment. The Jet Nozzles 46 are shown as being connected via a Fluid Manifold 48. The Fluid Manifold 48 is connected to a Pump Line Sleeve 50 which connects it to the Fluid Line 52. The Fluid Line 52 is connected to the Fluid Connector 10, which is connected to the Fluid Pump 8. The Jet Nozzles 46 are preferably designed collectively to utilize the same fluid rate and pressure as the Nozzle 26 used. The Jet Nozzles 46 are the preferred fluid expulsion system for use with the Lifting Plate 44, but other configurations that achieve the required spray pattern may be used.

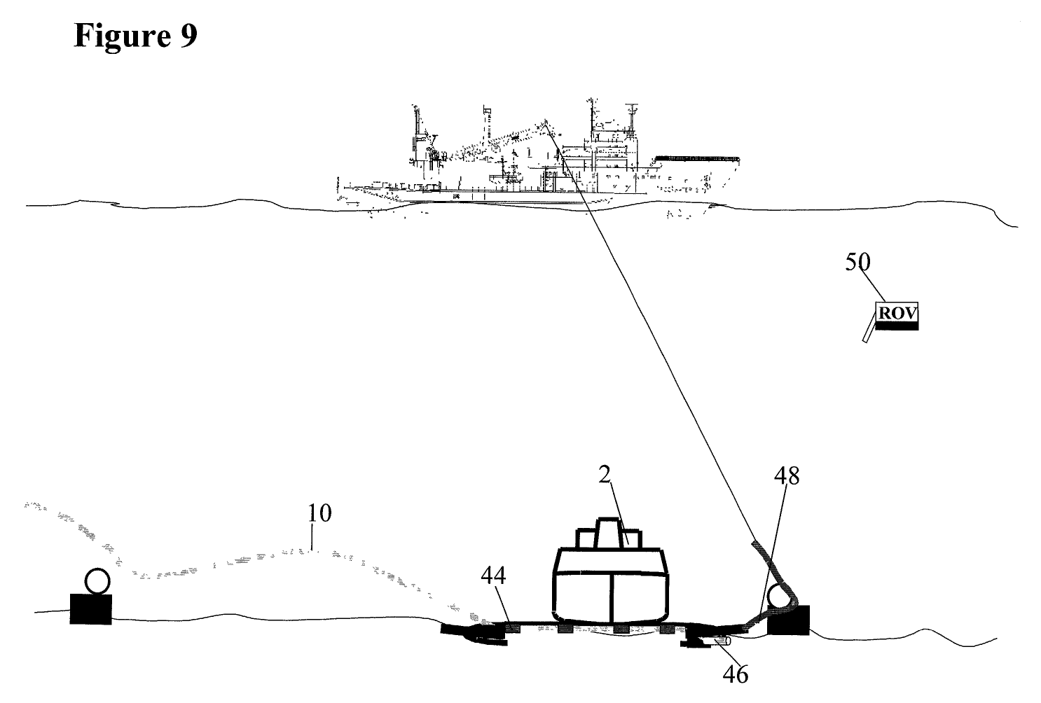

The process of the preferred embodiment utilizes an ROV to cut the Cable Loops 42 when the Coiled Tubing 18 has been fully retracted back onto Reel 20 and the cable 40 has been pulled through Borehole 38. The ROV can then disconnect the Fluid Connector 10 from the CTU 6, and the CTU may be moved or pulled to the surface. The ROV can then connect the Cable 40 to a pulley system to pull the Sling Cable under the Ship 2 through the Borehole 38. The ROV can then connect the Sling Cable to the Lifting Plate 44 and connect the Fluid Connector 10 to the Fluid Line 52. The Fluid Pump can then be turned on again, either remotely, or using the ROV. The Lifting Plate 44 of the preferred embodiment can then be pulled through the Borehole 38 with the Sling Cable while the Jet Nozzles 46 clear the way. FIG. 9 shows the Lifting Plate 44 as it has been pulled under the Ship 2, with Sling Cable 48. The Jet Nozzles 46 can be seen under the front edge of the Lifting Plate 44. The Fluid Connector 10 is shown as it is connected to the back edge of the Lifting Plate 44. The ROV 50 is used to determine when the front edge of the Lifting Plate has made it under the Ship 2. At that point the Fluid Pump 8 can be turned off, and the ROV can be used to disconnect the Fluid Connector 10. The Fluid Pump 8 may be moved or taken to the surface at this point. Rather than pulling the Lifting Plate 44 through the borehole, the fluid expulsion system could be designed to clear a path for the Lifting Plate 44 while at the same time pushing the plate ahead using fluid pressure, similar to the Hydraulic Drilling Nozzle 26.

The preferred embodiment of the present invention may be repeated as many times as necessary to place the number of Lifting Plates 44, or other salvage tools, under the Ship 2 or other submerged object, as the salvage operation calls for.

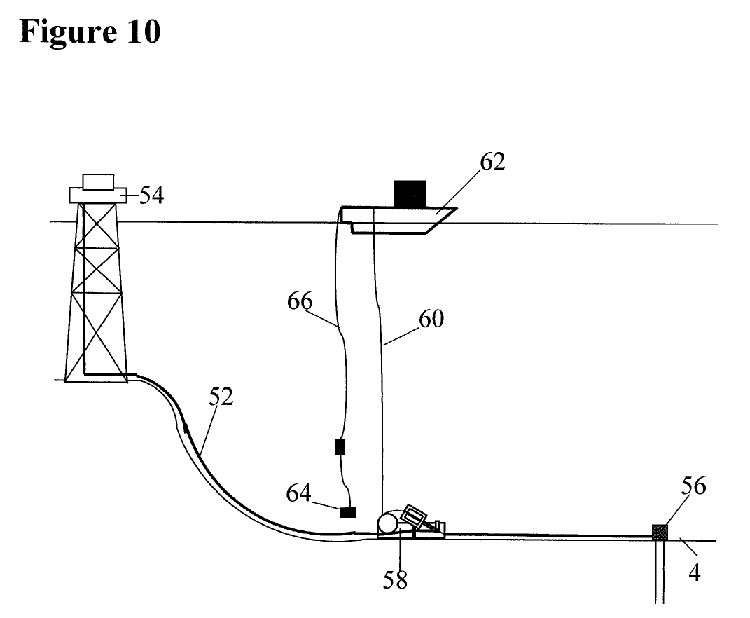

An additional preferred embodiment of the present invention is the use of coiled tubing in sub sea operations for pipeline cleanout operations. FIG. 10 shows the general configuration of a sub sea Pipeline 52 connected between a Host Platform 54 and a Sub Sea Wellhead 56. The CTU/Hot Tap System 58 is positioned on the Pipeline 52 or the Ocean Floor 4. The CTU/Hot Tap System 58 is operated through an Umbilical Cable 60 from a Ship 62. An ROV 64 is also operated remotely through Umbilical Cable 66.

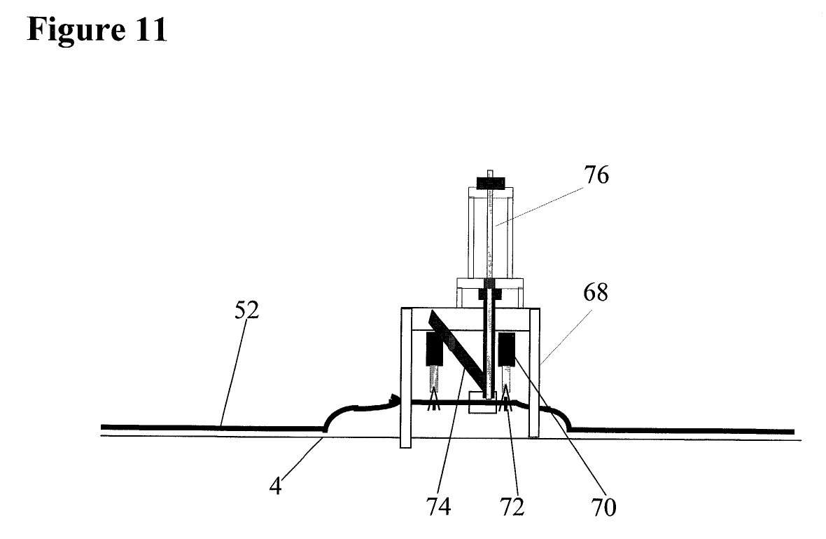

The preferred embodiment of the present invention starts with all equipment on the Ship 62. The Pipeline 52 is located using conventional methods. The Sub Sea Pipeline Hot Tap Substructure 68 shown in FIG. 11 is lowered to the Sea Floor 4 and positioned by using the ROV 64 to observe the placement from the Ship 62. The Substructure 68 has Hydraulic Cylinders 70 with Claws 72 that may be used to catch the Pipeline 52 and raise it off the Sea Floor 4. This operation can be run remotely, or using the ROV 64. Other equipment that can raise the Pipeline 52 off the Sea Floor 4 could be utilized. Once the Pipeline 52 is secured above the Sea Floor 4, a Hot Tap Saddle with Coiled Tubing Pipeline Entry Guide 74 is installed on the Pipeline 52 utilizing the ROV 64. The Coiled Tubing Entry Guide 74 is designed to allow Coiled Tubing 18 to enter Pipeline 52 after the hot tap operation. It is designed to minimize the angle of entry into the Pipeline 52 while maintaining a sufficient through bore to the Pipeline 52. The angle of entry is important to allow the Coiled Tubing 18 to enter and exit the Pipeline 52 with minimal frictional drag. Criteria that determine the specifications of the Coiled Tubing Entry Guide 74 are pipeline diameter, coiled tubing diameter, and diameter of the tool string that will be used in the pipeline cleanout operation. A conventional Sub Sea Hot Tap Machine 76 is then connected to the Hot Tap Saddle 74. Hot Tap Substructure 68 and connected to Hot Tap Saddle 74. The hot tap is then completed using conventional techniques. The Sub Sea Hot Tap Machine 76 is then brought back to the Ship 62. This operation can be performed using standard crane lifting techniques, or using the ROV 64 or divers.

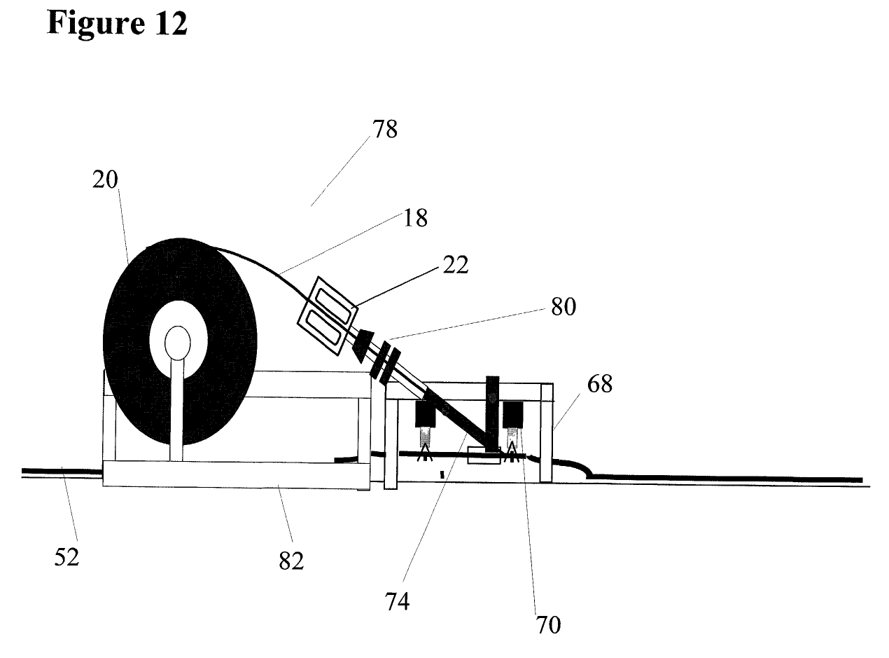

At this point in the preferred method, the Sub Sea Coiled Tubing Unit 78 is deployed as shown in FIG. 12. Sub Sea Coiled Tubing Unit 78 is made up of a Reel 20, Coiled Tubing 18, and an Injector Head 22 just as was described in the previous embodiment. In addition, this Unit 78 contains Pressure Control Equipment 80, as well as a CTU Substructure 82 configured to fit over the raised Pipeline 52. When the Unit 78 is lowered and the CTU Substructure 82 is properly positioned, the ROV 64 is used to connect the Pressure Control Equipment 80 to the Coiled Tubing Entry Guide 74. Any form of standard Coiled Tubing Pipeline clean out nozzle may be used.

In the preferred embodiment, a fluid pump is lowered to the Sea Floor 4 and connected to the Sub Sea Coiled Tubing Unit 78 using the ROV 64. If only sea water is necessary for the clean out, an intake system as described above for salvage operations can be utilized. If chemicals are needed, the storage is preferably maintained on the Ship 62 with only a low pressure suction pipe going to the sub sea fluid pump, but a fluid pump located on the surface ship 62 and a high pressure pump line from the fluid pump to the coiled tubing unit could be used. The returns are preferably taken through the Pipeline 52 at the Host Platform 52. Once the cleanout is complete, the Coiled Tubing 18 is retrieved and the connections are flushed with seawater so that when the Pressure Control Equipment 80 is disconnected, petroleum products will not leak.

Multiple Hot Taps and Coiled Tubing Cleanouts may be required for long pipelines.

At this point, the Sub Sea Coiled Tubing Unit 78 is retrieved. Depending on anticipated future needs, the Hot Tap Substructure 68 can be retrieved leaving the Hot Tap Saddle with Coiled Tubing Pipeline Entry Guide 74, or if future work is considered likely, the entire Hot Tap Substructure 68 can be left on the Sea Floor 4.

The coil tubing system for use with any of the methods of the present invention can be configured based on the need, including use of a coil tubing reel, a string of coil tubing, a coil tubing injector head, a hydraulic power pack, pressure control equipment, fluid pump and a fluid handling system. For long term undersea use, some modifications to standard coiled tubing units will need to be made. The bearings in the equipment will need to be replaced with plastic based bearings, and the hydraulic seals will need to be enhanced. Additionally, check valves or other techniques may be necessary to permit pressure balancing between the sealed interior and the pressure on the sea floor. All metal materials will preferably be designed to withstand exposure to salt and water.

The coil tubing system once placed on the ocean floor may be operated remotely either through umbilical cables up to a floating vessel or platform or using remote operated vehicles. Many coiled tubing systems are operated remotely today, so the umbilical cables merely need to be lengthened to allow for the ocean depth. Different equipment to be used with a coil tubing unit and the placement of a coil tubing unit will depend on the particular application for which it is being used. Generally, the coiled tubing system will be lowered from a ship using a wench system. In a preferred embodiment, the umbilical cord itself includes a stainless steel, or other capable material, that will permit the coiled tubing unit to be lowered using its own umbilical cable.

Additionally, while the preferred embodiments are directed to under sea work, the present invention would be useful for any under water work. In shallow depths, divers could perform any of the operations of the ROV. Additionally, once coiled tubing systems are used on the sea floor, other applications such as well drilling or drilling test wells looking for traces of hydrocarbons, gas hydrates, shallow water flows, or other products, or drilling testing for such things as under water volcanoes, caves or geologic formations.

We claim:

1. A method for performing underwater operations comprising the use of a submerged coiled tubing unit.

2. The method of claim 1 wherein the underwater operations are performed in the ocean.

3. The method of claim 1 wherein said underwater operations comprise salvage operations.

4. The method of claim 1 wherein said underwater salvage operations comprise sub sea pipeline cleanout operations.

5. A method for performing underwater salvage operations comprising the use of an underwater coiled tubing unit.

6. A method of performing underwater pipeline cleanout operations comprising the use of an underwater coiled tubing unit.

7. The method of claim 1 further comprising the use of a submerged fluid pump coupled to said coiled tubing unit.

8. A method of performing underwater pipeline cleanout operations comprising:
installing a sub sea hot tap system,
creating a hot tap into said pipeline
installing a coiled tubing unit over said pipeline
inserting the coiled tubing into the pipeline; and
cleaning out said pipeline.

9. The method of claim 8 wherein said coiled tubing unit includes pressure control equipment.

10. The method of claim 9 further comprising the use of a sub sea fluid pump coupled to said coiled tubing unit, wherein said fluid pump is used to pump the fluid used for said step of cleaning out said pipeline.

11. The method of claim 10 further comprising the step of supplying said fluid pump with sea water for use in said clean out step.

12. The method of claim 10 further comprising the step of supplying said fluid pump with chemical solutions for use in said clean out step.

13. The method of claim 12 wherein the chemical solutions are stored on a surface vessel, and are supplied by a suction line to said underwater fluid pump.

14. The method of claim 9 comprising the use of a fluid pump at the surface coupled to said coiled tubing unit through a pump line, wherein said fluid pump is used to pump the fluid used for said step of cleaning out said pipeline.

15. A method of performing underwater operations comprising:
locating a coiled tubing unit adjacent to submerged equipment; and
utilizing said coiled tubing unit to drill under said submerged equipment.

16. The method of claim 15 wherein said step of drilling under said submerged equipment further comprises utilizing a hydraulic jet nozzle.

17. The method of claim 16 wherein said step of drilling under said submerged equipment further comprises the use of a fluid pump to provide fluid to said coiled tubing unit.

18. A lifting plate for underwater salvage operation comprising:
a fluid manifold; and
at least one hydraulic expulsion system

19. The lifting plate of claim 18 wherein said hydraulic expulsion system comprises at least on hydraulic jet nozzle.

20. The lifting plate of claim 18 further comprising a connection to a fluid line from a fluid pump.

21. A method of inserting a lifting plate under submerged equipment comprising pumping fluid through a hydraulic expulsion system coupled to said lifting plate.

22. The method of claim 21 further comprising pulling said lifting plate with cable through a borehole passing under said submerged equipment.

23. The method of claim 22 wherein said borehole was created using a submerged coiled tubing unit.

24. A method of underwater drilling comprising:
placing a coiled tubing unit near the ocean floor;
placing a fluid pump adjacent to said coiled tubing unit;
coupling said fluid pump to said coiled tubing unit;
using an injector head to force the coiled tubing under said ocean floor; and
utilizing a drilling implement coupled to said coiled tubing to drill through said ocean floor.

25. The method of claim 24 wherein said ocean floor is the floor of a fresh water body of water.

26. The method of claim 24 wherein said drilling implement is a hydraulic drilling nozzle.

27. The method of claim 26 further comprising using a bending apparatus to create a curvature to the resulting borehole.

28. The method of claim 24 wherein said drilling implement is a rotary bit coupled to a motor.
